(19) United States
(12) Patent Application Publication
(10) Pub. No.: US 2025/0370248 A1
(43) Pub. Date: Dec. 4, 2025

(54) BEAM DIRECTORS

(71) Applicant: The Boeing Company, Arlington, VA (US)

(72) Inventor: Mark D. Fuller, Snohomish, WA (US)

(21) Appl. No.: 18/677,676

(22) Filed: May 29, 2024

(51) Int. Cl. G02B 26/12; G02B 26/08

(52) U.S. Cl. CPC G02B 26/12; G02B 26/0816

(57) ABSTRACT

Beam directors comprise a first mirror surface configured to be selectively rotated about a rotation axis, a second mirror surface facing the first mirror surface and configured to be selectively rotated about the rotation axis independent of rotation of the first mirror surface, and an electromagnetic radiation (EMR) device configured to emit or detect EMR along the rotation axis toward or from the first mirror surface. The first mirror surface and the second mirror surface are angled relative to the rotation axis so that at a plurality of rotational positions of the first mirror surface relative to the second mirror surface, the EMR directed along the rotation axis bounces off the first mirror surface and the second mirror surface.

### FIELD

The present disclosure relates to beam directors.

### BACKGROUND

Across various industries, electromagnetic radiation (EMR) is emitted and/or received for various applications. Precise alignment of an EMR emitting or detecting device typically requires cumbersome mechanical assemblies with various drawbacks. For example, gimbal systems are limited in rotation and often require that the active optical elements are mounted on the gimbal system itself. Stacked actuator systems, such as with an elevation/azimuth single mirror are commonly used in laser tracker metrology systems. Single mirror systems have a limited field of elevation, and multi-mirror systems are heavy with limited mechanical performance. Galvanometer actuator systems include dual mirror systems with limited rotation on each actuator. They are capable of very fast pointing, but have a very limited pointing range, often no more than a few tens of degrees in elevation and azimuth.

### SUMMARY

Beam directors comprise a first mirror surface, a second mirror surface, and an electromagnetic radiation (EMR) device. The first mirror surface is configured to be selectively rotated about a rotation axis that intersects the first mirror surface. The first mirror surface is neither perpendicular nor parallel to the rotation axis. The second mirror surface faces the first mirror surface and is configured to be selectively rotated about the rotation axis independent of rotation of the first mirror surface. The second mirror surface is neither perpendicular nor parallel to the rotation axis. The EMR device is configured to emit or detect EMR along the rotation axis toward or from the first mirror surface, and the first mirror surface and the second mirror surface are angled relative to the rotation axis so that at a plurality of rotational positions of the first mirror surface relative to the second mirror surface, the EMR directed along the rotation axis bounces off the first mirror surface and the second mirror surface.

### BRIEF DESCRIPTION OF THE DRAWINGS

FIG. 1 is a schematic illustration representing beam directors according to the present disclosure.

FIG. 2 is an isometric view of an example beam director according to the present disclosure.

FIG. 3 is another isometric view of the example beam director of FIG. 2.

FIG. 4 is another isometric view of the example beam director of FIG. 2.

FIG. 5 is another isometric view of the example beam director of FIG. 2.

FIG. 6 is another isometric view of the example beam director of FIG. 2.

FIG. 7 is another isometric view of the example beam director of FIG. 2.

FIG. 8 is another isometric view of the example beam director of FIG. 2.

FIG. 9 is another isometric view of the example beam director of FIG. 2.

FIG. 10 is another isometric view of the example beam director of FIG. 2.

FIG. 11 is another isometric view of the example beam director of FIG. 2.

FIG. 12 is another isometric view of the example beam director of FIG. 2.

FIG. 13 is another isometric view of the example beam director of FIG. 2.

FIG. 14 is another isometric view of the example beam director of FIG. 2.

FIG. 15 is another isometric view of the example beam director of FIG. 2.

FIG. 16 is an isometric view of another example beam director according to the present disclosure.

FIG. 17 is an isometric view of another example beam director according to the present disclosure.

FIG. 18 is an isometric view of another example beam director according to the present disclosure.

### DESCRIPTION

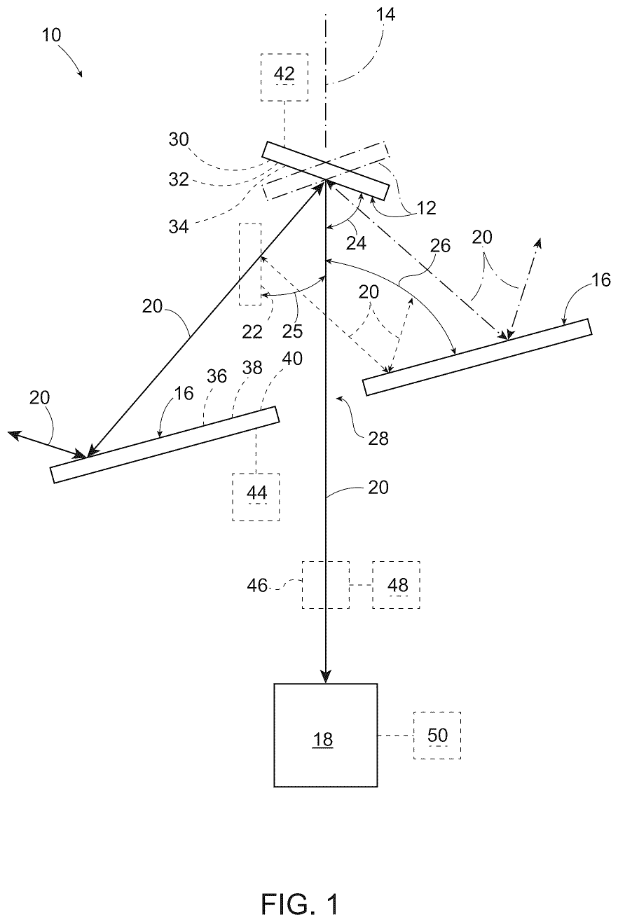

FIG. 1 schematically illustrates beam directors 10 according to the present disclosure. Generally, in FIG. 1, elements that are likely to be included in a given example are illustrated in solid lines, while elements that are optional to a given example or that correspond to a specific example are illustrated in dashed lines. Elements illustrated in dash dot lines represent an alternative position of the illustrated element. However, elements that are illustrated in solid lines are not essential to all examples of the present disclosure, and an element shown in solid lines may be omitted from a particular example without departing from the scope of the present disclosure.

As schematically represented in FIG. 1, beam directors 10 according to the present disclosure generally comprise at least a first mirror surface 12, a second mirror surface 16, and an electromagnetic radiation (EMR) device 18. The first mirror surface 12 is configured to be selectively rotated about a rotation axis 14 that intersects the first mirror surface 12, and the first mirror surface 12 is neither perpendicular nor parallel to the rotation axis 14. The second mirror surface 16 faces the first mirror surface 12 and is configured to be selectively rotated about the rotation axis 14 independent of the first mirror surface 12. The second mirror surface 16 also is neither perpendicular nor parallel to the rotation axis 14. The EMR device 18 is configured to emit or detect electromagnetic radiation (EMR) 20 along the rotation axis 14 toward or from the first mirror surface 12. In particular, the first mirror surface 12 and the second mirror surface 16 are angled relative to the rotation axis 14 so that at a plurality of rotational positions of the first mirror surface 12 relative to the second mirror surface 16, the EMR 20 directed along the rotation axis 14 bounces off the first mirror surface 12 and the second mirror surface 16. As a result, selective rotational positioning of the first mirror surface 12 and the second mirror surface 16 about the rotation axis 14 results in emission and/or detection of EMR 20 by the EMR device 18 generally in at least a full hemispherical range. In some examples, a greater than hemispherical range of emission and detection may be obtained based on the angles of first mirror surface 12 and the second mirror surface 16 relative to the rotation axis 14 and based on the relative rotational positions of the first mirror surface 12 and the second mirror surface 16. The extent of the region to or from which EMR 20 may be emitted or detected by a beam director 10 may be referred to herein as the range of the beam director 10.

In some examples, the first mirror surface 12 and the second mirror surface 16 are angled relative to the rotation axis 14 so that, regardless of a rotational position of the first mirror surface 12 relative to the second mirror surface 16, the EMR 20 directed along the rotation axis 14 bounces off the first mirror surface 12 and the second mirror surface 16. That is, although not required in all examples, the first mirror surface 12 and the second mirror surface 16 may be angled such that regardless of the relative rotational positions of the first mirror surface 12 and the second mirror surface 16, EMR 20 emitted by the EMR device 18 along the rotation axis 14 will not miss, or bypass, the second mirror surface 16.

As schematically and optionally represented in FIG. 1, some beam directors 10 further comprise a third mirror surface 22 that is configured to be selectively rotated about the rotation axis 14 with the first mirror surface 12. In such examples, the first mirror surface 12, the second mirror surface 16, and the third mirror surface 22 are angled relative to the rotation axis 14 so that at a plurality of rotational positions of the first mirror surface 12 and the third mirror surface 22 relative to the second mirror surface 16, the EMR 20 directed along the rotation axis 14 bounces off the first mirror surface 12, the second mirror surface 16, and the third mirror surface 22. By including a third mirror surface 22 that is fixed relative to the first mirror surface 12, the overall size of a beam director 10 may be able to be reduced. More specifically, a smaller second mirror surface 16 may be utilized, while resulting in the same range of a beam director 10 than a beam director 10 without a third mirror surface 22.

In some examples, the first mirror surface 12, the second mirror surface 16, and the third mirror surface 22 are angled relative to the rotation axis 14 so that regardless of a rotational position of the first mirror surface 12 and the third mirror surface 22 relative to the second mirror surface 16, the EMR 20 directed along the rotation axis 14 bounces off the first mirror surface 12, second mirror surface 16, and the third mirror surface 22. That is, although not required in all examples, the first mirror surface 12, the second mirror surface 16, and the third mirror surface 22 may be angled such that regardless of their relative rotational positions, EMR 20 emitted by the EMR device 18 along the rotation axis 14 will not miss, or bypass, the second mirror surface 16.

With continued reference to FIG. 1, the first mirror surface 12, the second mirror surface 16, and the optional third mirror surface 22 are indicated as being at a first mirror angle 24, second mirror angle 26, and a third mirror angle 25, respectively, relative to the rotation axis 14. In some examples of beam directors 10, the first mirror angle 24 is fixed. In some examples, when the third mirror surface 22 is present, the third mirror angle 25 is fixed. In other examples, the first mirror angle 24 is configured to be selectively adjusted. In some examples, the second mirror angle 26 is fixed. In some examples, the first mirror angle 24 and the second mirror angle 26 are the same. In other examples, the first mirror angle 24 and the second mirror angle 26 are different. In yet other examples, the second mirror angle 26 is configured to be selectively adjusted. In some examples, the third mirror angle 25 is configured to be selective adjusted.

As schematically illustrated in FIG. 1, in some examples of beam directors 10, the second mirror surface 16 defines an aperture 28, and the rotation axis 14 extends through the aperture 28. Accordingly, the EMR 20 emitted or detected by the EMR device 18 along the rotation axis 14 is not obstructed between the EMR device 18 and the first mirror surface 12.

Depending on the application of a beam director 10, in some examples, the first mirror surface 12 and/or the third mirror surface 22 is/are planar; in other examples, the first mirror surface 12 and/or the third mirror surface 22 is/are concave; in yet other examples, the first mirror surface 12 and/or the third mirror surface 22 is/are convex; and in yet other examples, the first mirror surface 12 and/or the third mirror surface 22 comprises a plurality of contours. For example, the first mirror surface 12 may comprise two or more of a (i) first-mirror planar region 30, (ii) a first-mirror concave region 32, or (iii) a first-mirror convex region 34. Similarly, in some examples, the third mirror surface 22 may comprise two or more of (i) a planar region, (ii) a concave region, or (iii) a convex region. In some examples of beam directors 10, the first mirror surface 12 and/or the third mirror surface 22 comprises a plurality of surface finishes and/or optic characteristics. As illustrative non-exclusive examples, one or more regions, or segments, of the first mirror surface 12 and/or the third mirror surface 22 may comprise one or more of holographic optics, optical grating(s), functional layers, transparency to specific wavelengths of EMR, meta material, filters, and so forth. For example, functional optical treatments may be used to separate wavelengths (spectroscopy), filter to include or exclude specific wavelengths or ranges of wavelengths (e.g., highpass, lowpass, notch), divert differing wavelengths to separate sensors, to combine EMR sources of differing wavelengths, perform optical functions analogous to lenses or mirrors of curved or arbitrary shape, focus multiple wavelengths to the same focal point, improve reflectivity (e.g., Bragg mirrors), induce or filter polarization states, etc.

Accordingly, in such examples having different contours and/or different surface finishes, the first mirror surface 12 may be selectively positioned relative to the rotation axis 14 to align a selected contour and/or a selected surface finish of the first mirror surface 12 with the rotation axis 14, thereby resulting in a desired optical effect on the EMR 20 being emitted or detected.

Similarly, depending on the application of a beam director 10, in some examples, the second mirror surface 16 is planar; in other examples, the second mirror surface 16 is concave; in yet other examples, the second mirror surface 16 is convex; and in yet other examples, the second mirror surface 16 comprises a plurality of contours. For example, the second mirror surface 16 may comprise two or more of a second-mirror planar region 36, a second-mirror convex region 38, and a second-mirror concave region 40. In some examples of beam directors 10, the second mirror surface 16 comprises a plurality of surface finishes and/or a plurality of optic characteristics. As illustrative non-exclusive examples, one or more regions, or segments, of the second mirror surface 16 may comprise one or more of holographic optics, optional grating(s), functional layers, transparency to specific wavelengths of EMR, meta material, filters, and so forth. For example, functional optical treatments may be used to separate wavelengths (spectroscopy), filter to include or exclude specific wavelengths or ranges of wavelengths (e.g., highpass, lowpass, notch), divert differing wavelengths to separate sensors, to combine EMR sources of differing wavelengths, perform optical functions analogous to lenses or mirrors of curved or arbitrary shape, focus multiple wavelengths to the same focal point, improve reflectivity (e.g., Bragg mirrors), induce or filter polarization states, etc.

Accordingly, in such examples having different contours and/or different surface finishes, the second mirror surface 16 may be selectively rotated relative to the first mirror surface 12 to that a desired portion of the second mirror surface is impinged by the EMR 20. For example, in an EMR detection application, a convex portion of the second mirror surface 16 initially may be used to locate a desired EMR signal, and once located, a planar portion or a concave portion of the second mirror surface 16 may then be used to focus the EMR 20 for detection by the EMR device 18.

As schematically represented in FIG. 1, some beam directors 10 further comprise a first-mirror motor 42 that is configured to operatively rotate the first mirror surface 12 about the rotation axis 14, and a second-mirror motor 44 configured to operatively rotate the second mirror surface 16 about the rotation axis 14. In some examples of beam directors 10, the first-mirror motor 42, the second-mirror motor 44, and the associated structure that operatively couples the first-mirror motor 42 and the second-mirror motor 44 to the first mirror surface 12 and the second mirror surface 16, may be spatially packaged to result in a compact and lightweight beam director 10, such as with a shared, or stacked, bearing package.

With continued reference to FIG. 1, some beam directors 10 further comprise an image erector 46 that is configured to erect the EMR 20 along the rotation axis 14 between the first mirror surface 12 and the EMR device 18. Examples of image erectors 46 include, but are not limited to, 3-mirror cells, dove prisms, triple pentaprisms, 4-Schmidt prisms, dual porro prisms, Pechan-roofs, and the like.

In some such examples, the image erector 46 is configured to be selectively rotated about the rotation axis 14 independent of rotation of the second mirror surface 16, and in some examples, the image erector 46 is configured to be selectively rotated about the rotation axis 14 with the first mirror surface 12 and/or with the EMR device 18. Accordingly, as schematically represented in FIG. 1, some beam directors 10 further comprise an image-erector motor 48 that is configured to operatively rotate the image erector 46 about the rotation axis 14. In other examples, the first-mirror motor 42 is further configured to operatively rotate the image erector 46 about the rotation axis 14 with the first mirror surface 12, thereby eliminating the need for a separate image-erector motor 48.

When present, the image erector 46 functions to rotate the received EMR (e.g., image) to a desired orientation, or, in the case of the entire system (including EMR) mounted on a rapidly rotating body, to continuously rotate so that the received EMR (e.g., image) is stabilized rotationally as received by the EMR device 18 to eliminate rotational motion blur. An image erector 46 also may function to provide a correction to eliminate blur when viewing a target that is itself rotating rapidly with respect to the pointed beam or view axis of the beam director 10. This function of matching the optical rotation to the target by blur minimization would also serve to measure the rotation rate of the target.

In some examples of beam directors 10, the EMR device 18 is configured to be selectively rotated about the rotation axis 14 with the first mirror surface 12. Accordingly, in applications of beam directors 10 wherein a continuous rotation of at least the first mirror surface 12 is utilized for sweeping emission or detection of EMR 20, the EMR device 18 need not be required to account for the relative rotation of the EMR 20, which may result in blurring of the associated EMR 20, depending on the speed of rotation of the first mirror surface 12. Accordingly, as schematically represented in FIG. 1, some beam directors 10 further comprise an EMR-device motor 50 that is configured to operatively rotate the EMR device 18 about the rotation axis. In other examples, the first-mirror motor 42 is further configured to operatively rotate the EMR device 18 about the rotation axis 14 with the first mirror surface 12, thereby eliminating the need for a separate EMR-device motor 50.

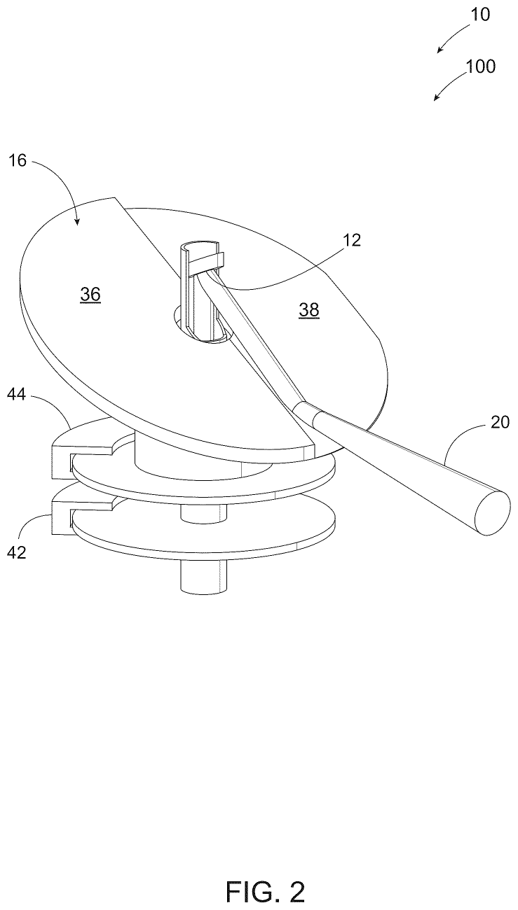

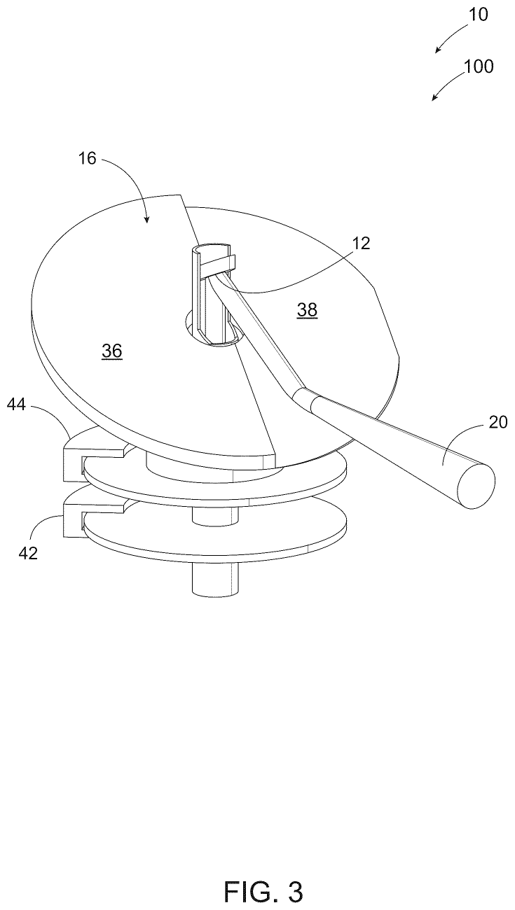

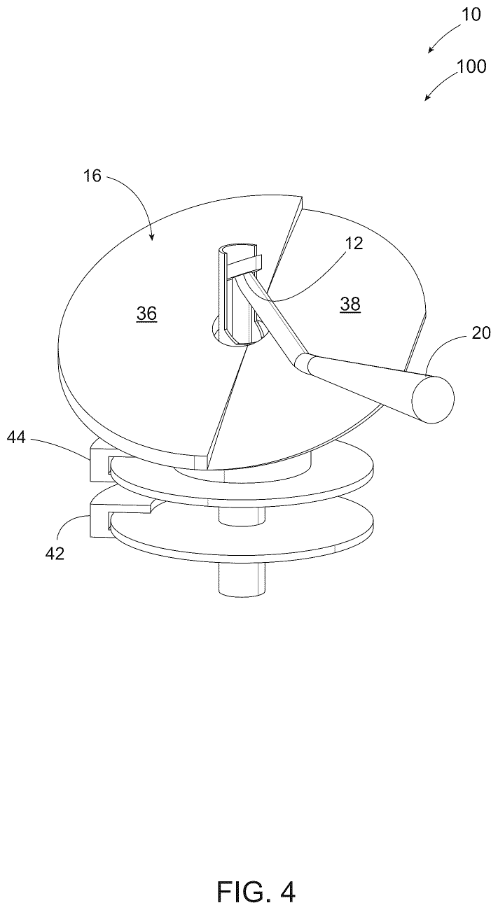

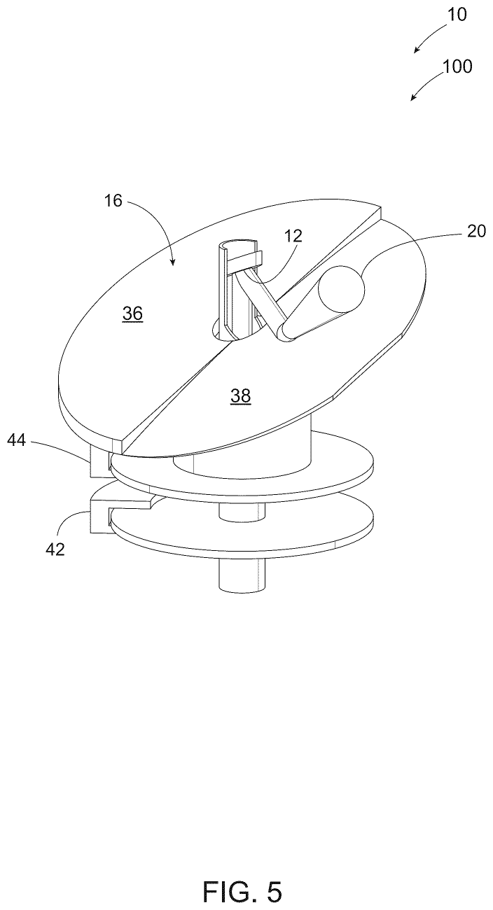

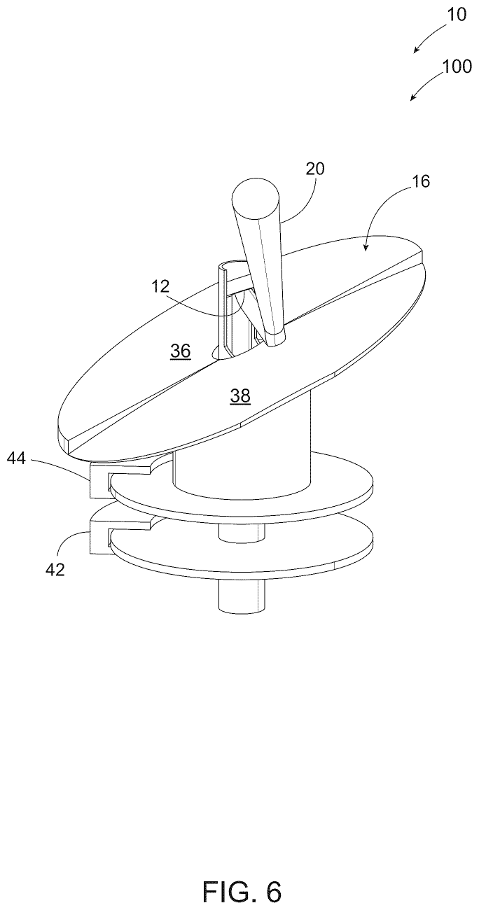

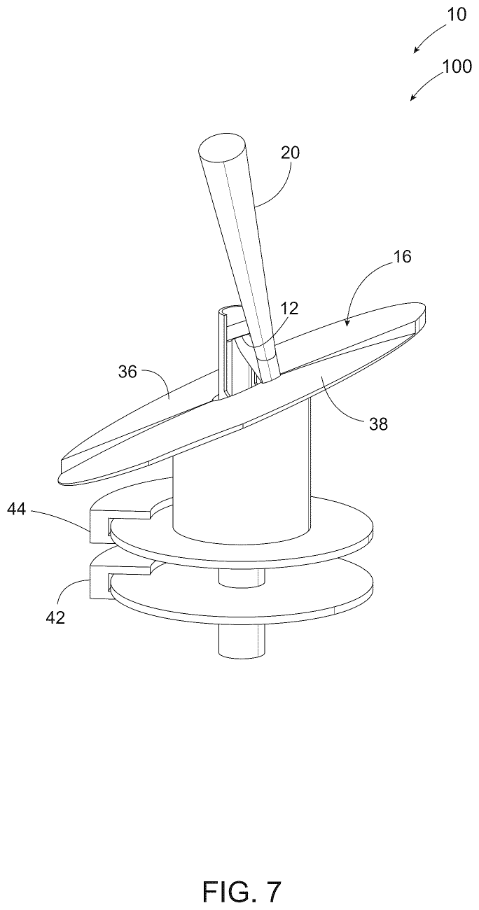

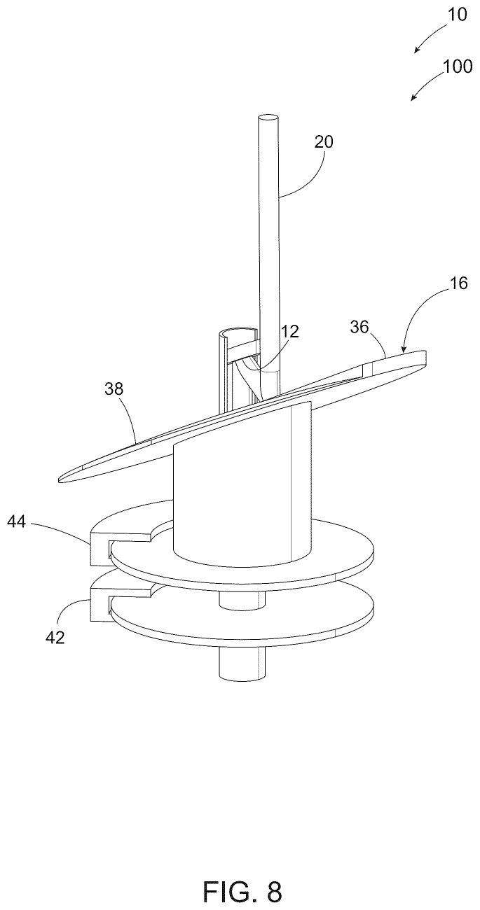

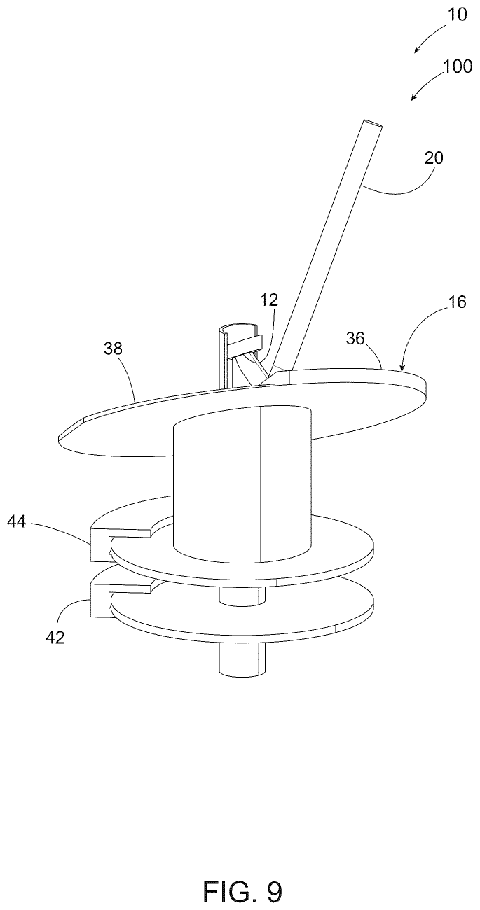

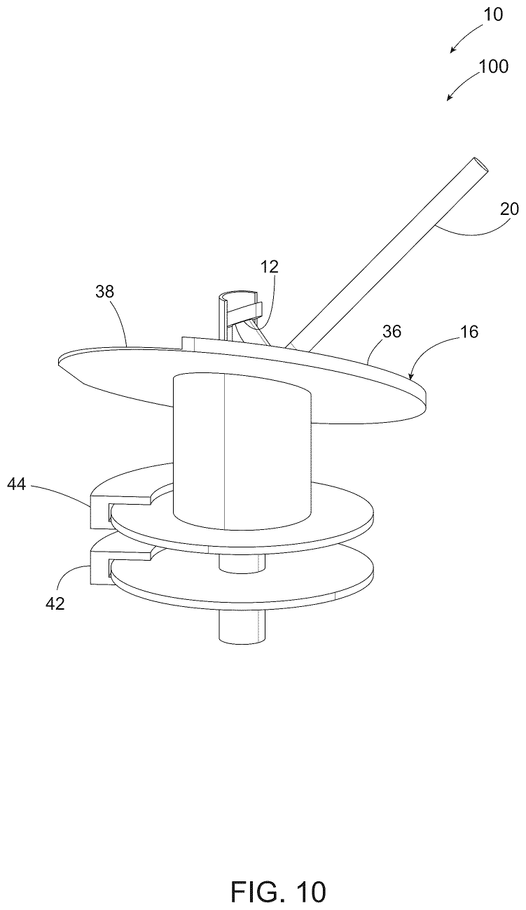

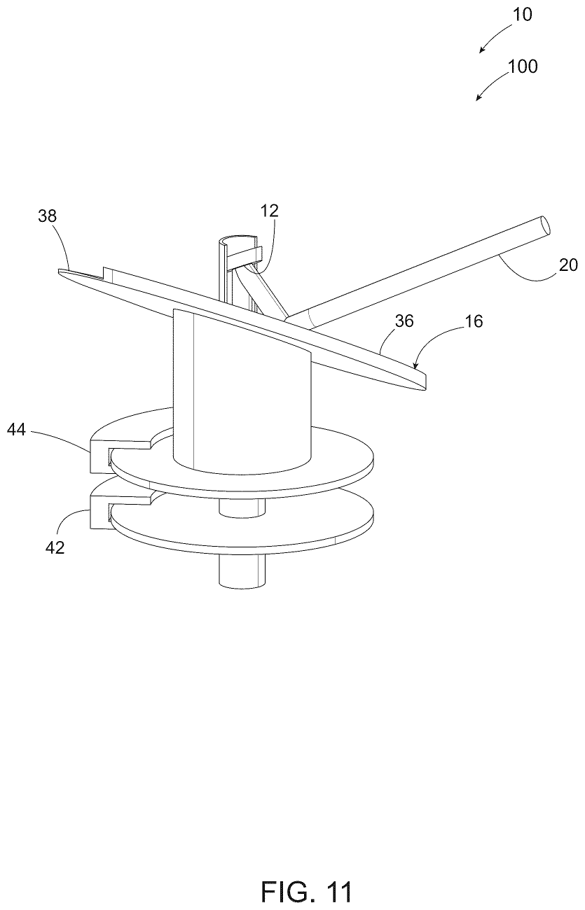

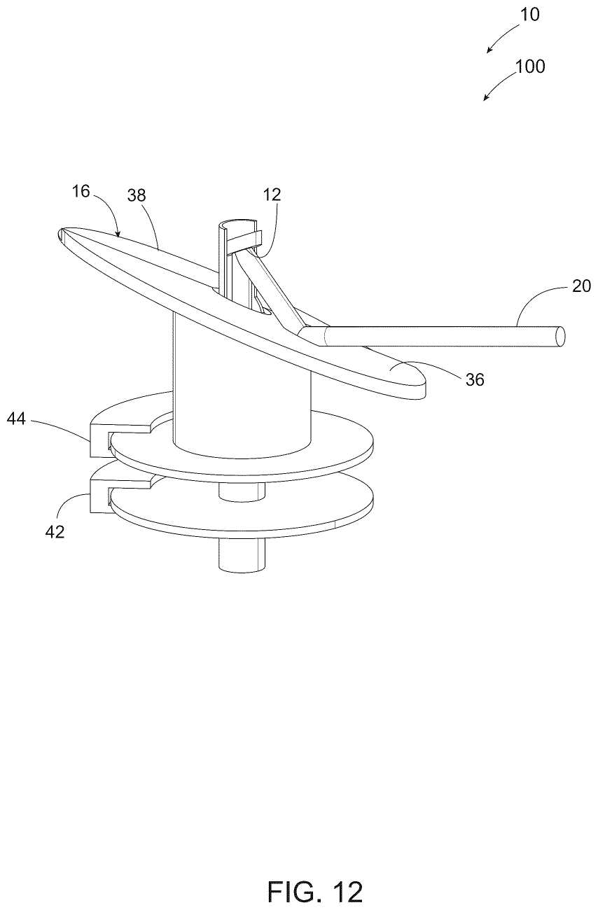

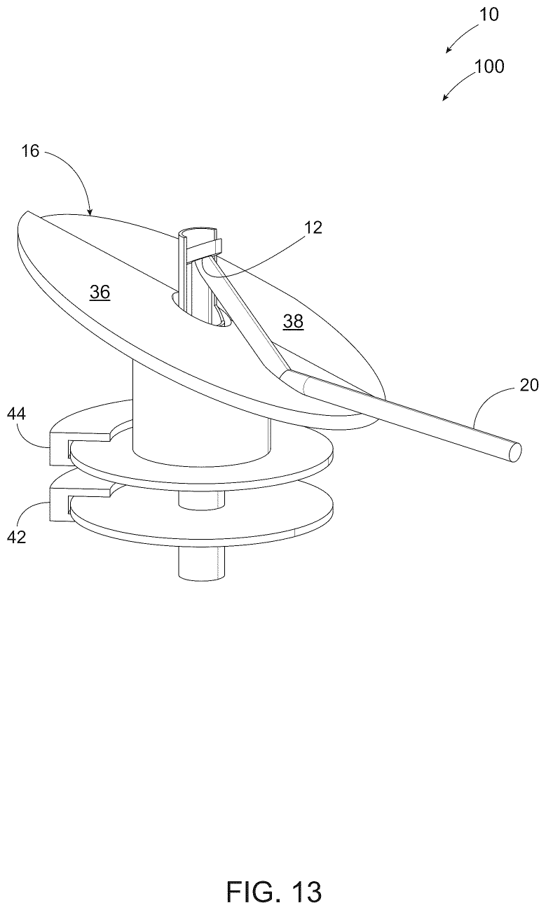

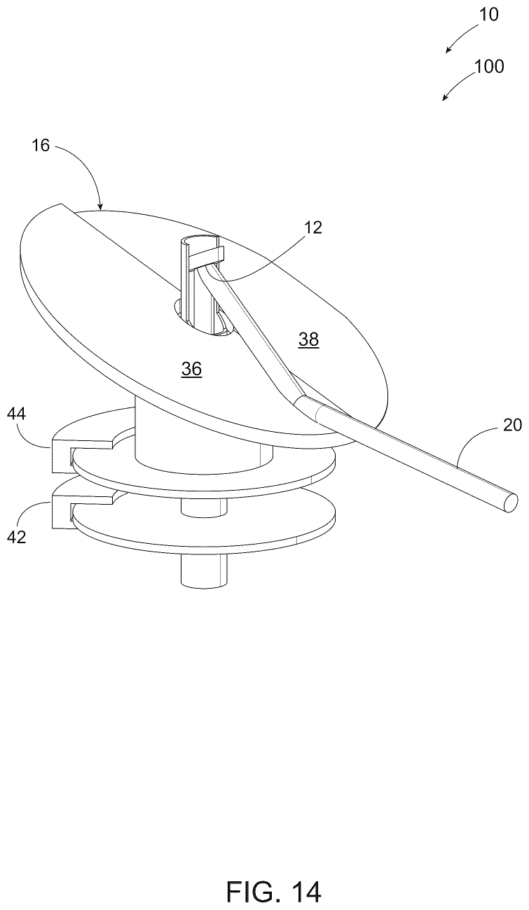

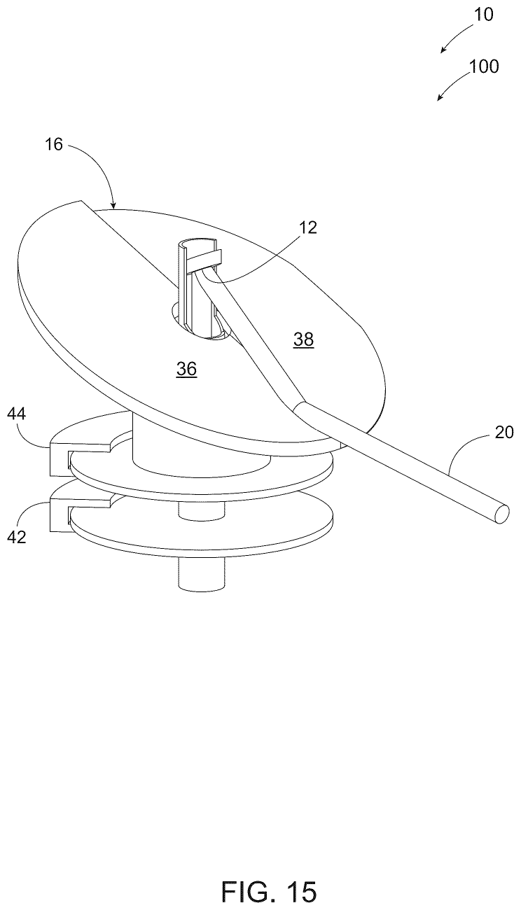

Turning now to FIGS. 2-18, illustrative non-exclusive examples of beam directors 10 are illustrated.

Where appropriate, the reference numerals from the schematic illustration of FIG. 1 are used to designate corresponding parts of the examples of FIGS. 2-18; however, the examples of FIGS. 2-18 are non-exclusive and do not limit beam directors 10 to the illustrated embodiments of FIGS. 2-18. That is, beam directors 10 may incorporate any number of the various aspects, configurations, characteristics, properties, etc. of beam directors 10 that are illustrated in and discussed with reference to the schematic representation of

FIG. 1 and/or the embodiments of FIGS. 2-18, as well as variations thereof, without requiring the inclusion of all such aspects, configurations, characteristics, properties, etc. For the purpose of brevity, each previously discussed component, part, portion, aspect, region, etc. or variants thereof may not be discussed, illustrated, and/or labeled again with respect to each embodiment of FIGS. 2-18; however, it is within the scope of the present disclosure that the previously discussed features, variants, etc. may be utilized with such embodiments.

FIGS. 2-15 illustrate beam director 100, which is an example of a beam director 10 whose second mirror surface 16 comprises a second-mirror planar region 36 and a second-mirror convex region 38. In particular, each of the second-mirror planar region 36 and the second-mirror convex region 38 account for about one-half of the overall second mirror surface 16. Beam director 100 comprises a first-mirror motor 42 operatively coupled to the first mirror surface 12 for rotation thereof, and a second-mirror motor 44 operatively coupled to the second mirror surface 16 for rotation thereof. FIGS. 2-15 illustrate beam director 100 with various rotational positions of the first mirror surface 12 relative to the second mirror surface 16 and thus with various directions of EMR 20 being affected.

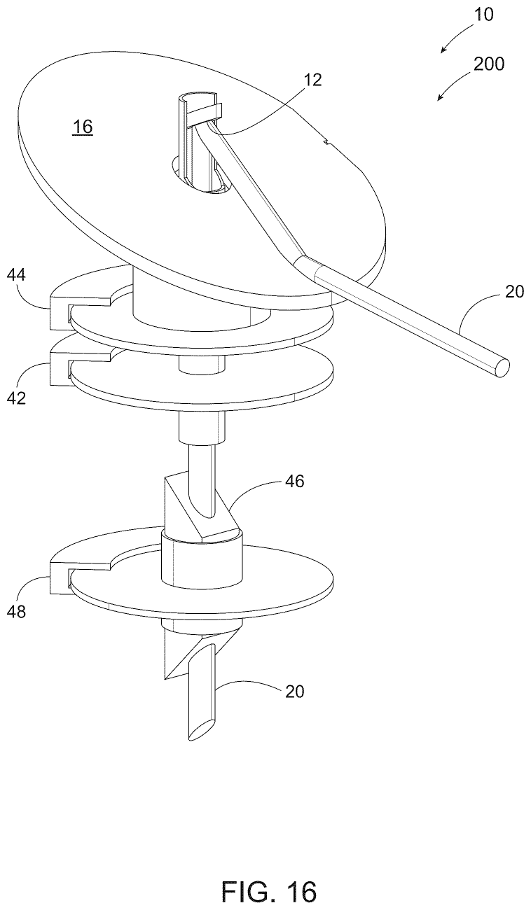

FIG. 16 illustrates beam director 200, which is an example of a beam director 10 that comprises a first-mirror motor 42, a second-mirror motor 44, an image erector 46, an image-erector motor 48, and a second mirror surface 16 that is planar.

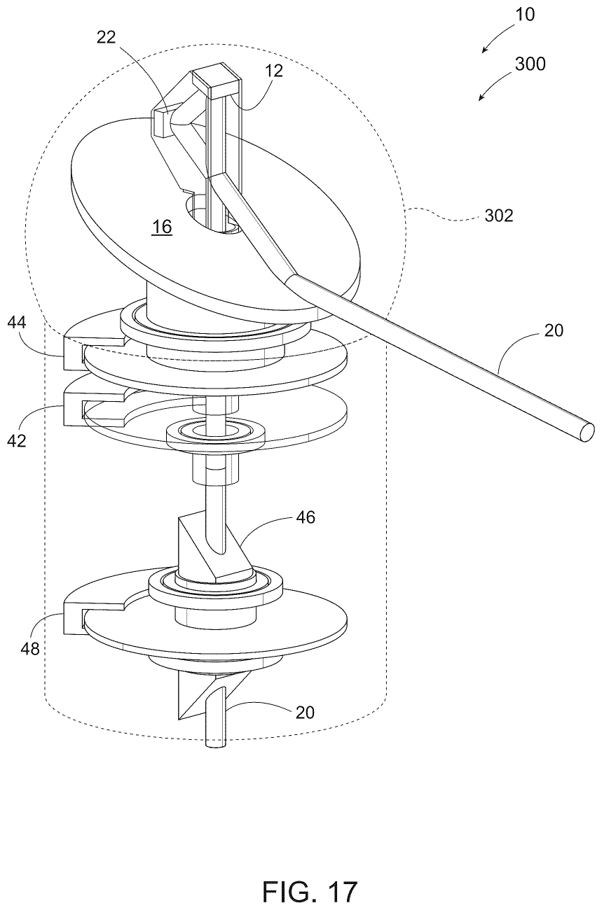

FIG. 17 illustrates beam director 300, which is another example of a beam director 10 that comprises a first-mirror motor 42, a second-mirror motor 44, an image erector 46, an image-erector motor 48, and a second mirror surface 16 that is planar. Beam director 300 further comprises a third mirror surface 22. In addition, beam director 300 comprises a spherical window 302 generally surrounding the first mirror surface 12, the second mirror surface 16, and the third mirror surface 22 for protection thereof.

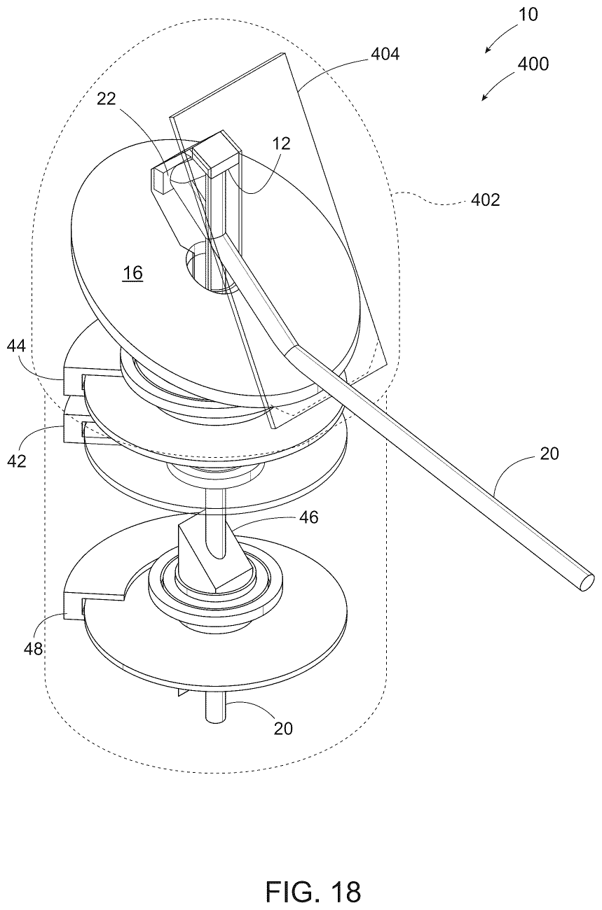

FIG. 18 illustrates a beam director 400, which is another example of a beam director 10 that comprises a first-mirror motor 42, a second-mirror motor 44, an image erector 46, an image-erector motor 48, a third mirror surface 22, and a second mirror surface 16 that is planar. Beam director 400 also comprises a domed housing 402 with a planar window 404 that are operatively coupled to the first mirror surface 12 and the third mirror surface 22 for rotation therewith, with the planar window 404 being aligned with the detection and/or emission of EMR 20. The planar window 404 may be subdivided with functional optical coatings that can be selected by aligning the region of the coating with the incoming/outgoing beam by further rotating the window housing with respect to the first mirror surface 12. Multiple planar windows also may be incorporated into a beam director 10, such as if the one window is of insufficient size to hold the number of functions desired for a particular application.

Illustrative, non-exclusive examples of inventive subject matter according to the present disclosure are described in the following enumerated paragraphs:

A. A beam director (10), comprising:
a first mirror surface (12) configured to be selectively rotated about a rotation axis (14) that intersects the first mirror surface (12), wherein the first mirror surface (12) is neither perpendicular nor parallel to the rotation axis (14);
a second mirror surface (16) facing the first mirror surface (12) and configured to be selectively rotated about the rotation axis (14) independent of rotation of the first mirror surface (12), wherein the second mirror surface (16) is neither perpendicular nor parallel to the rotation axis (14); and
an electromagnetic radiation (EMR) device (18) configured to emit or detect EMR (20) along the rotation axis (14) toward or from the first mirror surface (12);
wherein the first mirror surface (12) and the second mirror surface (16) are angled relative to the rotation axis (14) so that at a plurality of rotational positions of the first mirror surface (12) relative to the second mirror surface (16), the EMR (20) directed along the rotation axis (14) bounces off the first mirror surface (12) and the second mirror surface (16).

A1. The beam director (10) of paragraph A, wherein the first mirror surface (12) and the second mirror surface (16) are angled relative to the rotation axis (14) so that regardless of a rotational position of the first mirror surface (12) relative to the second mirror surface (16), the EMR (20) directed along the rotation axis (14) bounces off the first mirror surface (12) and the second mirror surface (16).

A2. The beam director (10) of any of paragraphs A-A1, further comprising:
a third mirror surface (22) configured to be selectively rotated about the rotation axis (14) with the first mirror surface (12);
wherein the first mirror surface (12), the second mirror surface (16), and the third mirror surface (22) are angled relative to the rotation axis (14) so that at a plurality of rotational positions of the first mirror surface (12) and the third mirror surface (22) relative to the second mirror surface (16), the EMR (20) directed along the rotation axis (14) bounces off the first mirror surface (12), the second mirror surface (16), and the third mirror surface (22).

A2.1. The beam director (10) of paragraph A2, wherein the first mirror surface (12), the second mirror surface (16), and the third mirror surface (22) are angled relative to the rotation axis (14) so that regardless of a rotational position of the first mirror surface (12) and the third mirror surface (22) relative to the second mirror surface (16), the EMR (20) directed along the rotation axis (14) bounces off the first mirror surface (12), second mirror surface (16), and the third mirror surface (22).

A3. The beam director (10) of any of paragraphs A-A2.1, wherein the first mirror surface (12) is at a first mirror angle (24) relative to the rotation axis (14), and wherein the first mirror angle (24) is fixed.

A3.1. The beam director (10) of paragraph A3 when depending from paragraph A2, wherein the third mirror surface (22) is at a third mirror angle (25), and wherein the third mirror angle (25) is fixed.

A4. The beam director (10) of any of paragraphs A-A2.1, wherein the first mirror surface (12) is at a first mirror angle (24) relative to the rotation axis (14), and wherein the first mirror angle (24) is configured to be selectively adjusted.

A5. The beam director (10) of any of paragraphs A-A4, wherein the second mirror surface (16) is at a second mirror angle (26) relative to the rotation axis (14), and wherein the second mirror angle (26) is fixed.

A5.1. The beam director (10) of paragraph A5 when depending from paragraph A3, wherein the first mirror angle (24) and the second mirror angle (26) are the same.

A5.2. The beam director (10) of paragraph A5 when depending from paragraph A3, wherein the first mirror angle (24) and the second mirror angle (26) are different.

A6. The beam director (10) of any of paragraphs A-A4, wherein the second mirror surface (16) is at a second mirror angle (26) relative to the rotation axis (14), and wherein the second mirror angle (26) is configured to be selectively adjusted.

A7. The beam director (10) of any of paragraphs A-A6, wherein the second mirror surface (16) defines an aperture (28), and wherein the rotation axis extends through the aperture (28).

A8. The beam director (10) of any of paragraphs A-A7, wherein the first mirror surface (12) is planar.

A10. The beam director (10) of any of paragraphs A-A7, wherein the first mirror surface (12) is concave.

A11. The beam director (10) of any of paragraphs A-A7, wherein the first mirror surface (12) is convex.

A12. The beam director (10) of any of paragraphs A-A7, wherein the first mirror surface (12) comprises a plurality of contours.

A12.1. The beam director (10) of paragraph A12, wherein the first mirror surface (12) comprises two or more of:
a first-mirror planar region (30);
a first-mirror concave region (32); and
a first-mirror convex region (34).

A13. The beam director (10) of any of paragraphs A-A12.1, wherein the first mirror surface (12) comprises a plurality of surface finishes.

A14. The beam director (10) of any of paragraphs A-A13, wherein the first mirror surface (12) comprises a plurality of optic characteristics.

A15. The beam director (10) of any of paragraphs A-A14, wherein the second mirror surface (16) is planar.

A16. The beam director (10) of any of paragraphs A-A14, wherein the second mirror surface (16) is concave.

A17. The beam director (10) of any of paragraphs A-A14, wherein the second mirror surface (16) is convex.

A18. The beam director (10) of any of paragraphs A-A14, wherein the second mirror surface (16) comprises a plurality of contours.

A18.1. The beam director (10) of paragraph A18, wherein the second mirror surface (16) comprises two or more of:
a second-mirror planar region (36);
a second-mirror convex region (38); and
a second-mirror concave region (40).

A19. The beam director (10) of any of paragraphs A-A18.1, wherein the second mirror surface (16) comprises a plurality of surface finishes.

A20. The beam director (10) of any of paragraphs A-A19, wherein the second mirror surface (16) comprises a plurality of optic characteristics.

A21. The beam director (10) of any of paragraphs A-A20, further comprising:
a first-mirror motor (42) configured to operatively rotate the first mirror surface (12) about the rotation axis (14); and
a second-mirror motor (44) configured to operatively rotate the second mirror surface (16) about the rotation axis (14).

A22. The beam director (10) of any of paragraphs A-A21, further comprising:
an image erector (46) configured to erect the EMR (20) along the rotation axis (14) between the first mirror surface (12) and the EMR device (18).

A22.1. The beam director (10) of paragraph A22, wherein the image erector (46) is configured to be selectively rotated about the rotation axis (14) independent of rotation of the second mirror surface (16).

A22.2. The beam director (10) of any of paragraphs A22-A22.1, wherein the image erector (46) is configured to be selectively rotated about the rotation axis (14) with the first mirror surface (12).

A22.3. The beam director (10) of any of paragraphs A22-A22.2, further comprising:
an image-erector motor (48) configured to operatively rotate the image erector (46) about the rotation axis (14).

A22.4. The beam director (10) of any of paragraphs A22-A22.2 when depending from paragraph A21, wherein the first-mirror motor (42) is further configured to operatively rotate the image erector (46) about the rotation axis (14) with the first mirror surface (12).

A23. The beam director (10) of any of paragraphs A-A22.4, wherein the EMR device (18) is configured to be selectively rotated about the rotation axis (14) with the first mirror surface (12).

A23.1. The beam director (10) of paragraph A23, further comprising:
an EMR-device motor (50) configured to operatively rotate the EMR device (18) about the rotation axis.

A23.2. The beam director (10) of paragraph A23 when depending from paragraph A21, wherein the first-mirror motor (42) is further configured to operatively rotate the EMR device (18) about the rotation axis (14) with the first mirror surface (12).

B. The use of the beam director (10) of any of paragraphs A-A23.2 to emit or detect EMR (20).

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the term “and/or” placed between a first entity and a second entity means one of (1) the first entity, (2) the second entity, and (3) the first entity and the second entity. Multiple entries listed with “and/or” should be construed in the same manner, i.e., “one or more” of the entities so conjoined. Other entities optionally may be present other than the entities specifically identified by the “and/or” clause, whether related or unrelated to those entities specifically identified. Thus, as a non-limiting example, a reference to “A and/or B,” when used in conjunction with open-ended language such as “comprising,” may refer, in one example, to A only (optionally including entities other than B); in another example, to B only (optionally including entities other than A); in yet another example, to both A and B (optionally including other entities). These entities may refer to elements, actions, structures, steps, operations, values, and the like.

The various disclosed elements of apparatuses and steps of methods disclosed herein are not required to all apparatuses and methods according to the present disclosure, and the present disclosure includes all novel and non-obvious combinations and sub-combinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

1. A beam director, comprising:
a first mirror surface configured to be selectively rotated about a rotation axis that intersects the first mirror surface, wherein the first mirror surface is neither perpendicular nor parallel to the rotation axis;
a second mirror surface facing the first mirror surface and configured to be selectively rotated about the rotation axis independent of rotation of the first mirror surface, wherein the second mirror surface is neither perpendicular nor parallel to the rotation axis; and
an electromagnetic radiation (EMR) device configured to emit or detect EMR along the rotation axis toward or from the first mirror surface;
wherein the first mirror surface and the second mirror surface are angled relative to the rotation axis so that at a plurality of rotational positions of the first mirror surface relative to the second mirror surface, the EMR directed along the rotation axis bounces off the first mirror surface and the second mirror surface.

2. The beam director of claim 1, wherein the first mirror surface and the second mirror surface are angled relative to the rotation axis so that regardless of a rotational position of the first mirror surface relative to the second mirror surface, the EMR directed along the rotation axis bounces off the first mirror surface and the second mirror surface.

3. The beam director of claim 1, further comprising:
a third mirror surface configured to be selectively rotated about the rotation axis with the first mirror surface;
wherein the first mirror surface, the second mirror surface, and the third mirror surface are angled relative to the rotation axis so that at a plurality of rotational positions of the first mirror surface and the third mirror surface relative to the second mirror surface, the EMR directed along the rotation axis bounces off the first mirror surface, the second mirror surface, and the third mirror surface.

4. The beam director of claim 1,
wherein the first mirror surface is at a first mirror angle relative to the rotation axis, and wherein the first mirror angle is fixed;
wherein the second mirror surface is at a second mirror angle relative to the rotation axis, and wherein the second mirror angle is fixed.

5. The beam director of claim 4, wherein the first mirror angle and the second mirror angle are the same.

6. The beam director of claim 1, wherein the second mirror surface defines an aperture, and wherein the rotation axis extends through the aperture.

7. The beam director of claim 1, wherein the first mirror surface is planar.

8. The beam director of claim 7, wherein the second mirror surface is planar.

9. The beam director of claim 7, wherein the second mirror surface comprises a plurality of contours.

10. The beam director of claim 9, wherein the second mirror surface comprises two or more of:
a second-mirror planar region;
a second-mirror convex region; and
a second-mirror concave region.

11. The beam director of claim 1, wherein the second mirror surface comprises a plurality of surface finishes.

12. The beam director of claim 1, wherein the second mirror surface comprises a plurality of optic characteristics.

13. The beam director of claim 1, further comprising:
a first-mirror motor configured to operatively rotate the first mirror surface about the rotation axis; and
a second-mirror motor configured to operatively rotate the second mirror surface about the rotation axis.

14. The beam director of claim 1, further comprising:
an image erector configured to erect the EMR along the rotation axis between the first mirror surface and the EMR device.

15. The beam director of claim 14, wherein the image erector is configured to be selectively rotated about the rotation axis independent of rotation of the second mirror surface.

16. The beam director of claim 14, wherein the image erector is configured to be selectively rotated about the rotation axis with the first mirror surface.

17. The beam director of claim 14, further comprising:
a first-mirror motor configured to operatively rotate the first mirror surface about the rotation axis, wherein the first-mirror motor is further configured to operatively rotate the image erector about the rotation axis with the first mirror surface; and
a second-mirror motor configured to operatively rotate the second mirror surface about the rotation axis.

18. The beam director of claim 1, wherein the EMR device is configured to be selectively rotated about the rotation axis with the first mirror surface.

19. A beam director, comprising:
a first mirror surface configured to be selectively rotated about a rotation axis that intersects the first mirror surface, wherein the first mirror surface is neither perpendicular nor parallel to the rotation axis, wherein the first mirror surface is at a first mirror angle relative to the rotation axis, and wherein the first mirror angle is fixed;
a second mirror surface facing the first mirror surface and configured to be selectively rotated about the rotation axis independent of rotation of the first mirror surface, wherein the second mirror surface is neither perpendicular nor parallel to the rotation axis, wherein the second mirror surface is at a second mirror angle relative to the rotation axis, wherein the second mirror angle is fixed, and wherein the first mirror angle and the second mirror angle are the same;
a first-mirror motor configured to operatively rotate the first mirror surface about the rotation axis;
a second-mirror motor configured to operatively rotate the second mirror surface about the rotation axis; and
an electromagnetic radiation (EMR) device configured to emit or detect EMR along the rotation axis toward or from the first mirror surface;
wherein the first mirror surface and the second mirror surface are angled relative to the rotation axis so that regardless of a rotational position of the first mirror surface relative to the second mirror surface, the EMR directed along the rotation axis bounces off the first mirror surface and the second mirror surface.

20. A beam director, comprising:
an electromagnetic radiation (EMR) device configured to emit or detect EMR along an axis; and
means for defining a greater than hemispherical range of emission or detection of EMR by the EMR device.
